(19) United States
(12) Patent Application Publication
(10) Pub. No.: US 2007/0236440 A1
(43) Pub. Date: Oct. 11, 2007

(54) OLED active matrix cell designed for optimal uniformity

(75) Inventors: Ihor Wacyk, Briarcliff, NY (US); Olivier Prache, Pleasantville, NY (US)

Correspondence Address: EPSTEIN DRANGEL BAZERMAN & JAMES, LLP, 60 EAST 42ND STREET, SUITE 820, NEW YORK, NY, 10165, US

(73) Assignee: eMagin Corporation

(21) Appl. No.: 11/399,170

(22) Filed: Apr. 6, 2006

(51) Int. Cl. G09G 3/36

(52) U.S. Cl. 345/92

(57) ABSTRACT

A drive circuit is provided for an OLED pixel display. The drive circuit is adapted for use with a reference voltage source. It includes a first transistor and an OLED. The output circuit of the first transistor is operably connected between the reference voltage source and the OLED. Transmission gate means responsive to a control signal are provided to transmit a data signal to the first transistor. Means are provided for controlling the first transistor in accordance with a time domain modulation signal to provide an average current to the OLED which is a function of the data signal.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO A “SEQUENCE LISTING”, A TABLE, OR A COMPUTER PROGRAM LISTING APPENDIX SUBMITTED ON COMPACT DISC

Not Applicable

### BACKGROUND OF THE INVENTION

1. Field of the Invention

The present invention relates to active matrix organic light emitting diode (AMOLED) pixel displays and more particularly to an AMOLED pixel cell design that minimizes or eliminates pixel to pixel non-uniformity in the pixel drive transistor threshold voltage resulting from the transistor fabrication process.

Active matrix displays in general require good pixel to pixel uniformity (over the entire gray scale range) in order to provide visually pleasing images. While a small variability is tolerable, when it reaches or exceeds 40 to 50%, it becomes unacceptable.

A source of variability in active matrix displays is the pixel drive transistor threshold voltage. Techniques exist to overcome this specific challenge be it for crystalline or non-crystalline silicon processes and have been applied to OLED displays with some success. The situation with AMOLED microdisplays is, however, more complex.

AMOLED microdisplays require very low amounts of current to generate light, especially when using analog gray scale rendition techniques. Traditionally, a long channel transistor is used to reduce the output current (OLEDs are best driven in current mode and voltage modes are not considered here because they are not practical). For low light level application, a typical OLED microdisplay pixel current is about 200 pA. However, realizing a compact circuit that can fit in a microdisplay application precludes the use of very long channel transistors.

This has led to reliance on a subthreshold mode of operation whereby the MOS transistor current can be scaled down to the required levels. This technique has been successfully implemented in eMagin Corporation's AMOLED microdisplay product line. However, while the circuit design compensates for voltage threshold variability, it does not address the variability of the subthreshold slope from device to device. This variability is totally random and due to microscopic changes within the gate oxide.

Because the MOS transistor output current has an exponential relationship to the voltage applied to transistor's gate when operating in the subthreshold region, a minor change in the slope can result in a large current difference between adjacent pixels. This manifests itself in random brighter pixels in an otherwise uniform field, leading to an unacceptable image quality for most display applications.

It is not practical to attempt to control the subthreshold slope variability. The main reason for that lies in the semiconductor process control capabilities with respect to random microscopic defects.

The present invention circumvents this issue by foregoing reliance on this operational method. Instead of using a direct analog control for generating gray levels, we employ a time domain modulation of the pixel drive transistor to yield an average current that, when converted to light by the OLED, represents the desired gray level.

In the circuit of the present invention, the pixel drive transistor is operated in the active (or saturation) region and thus at a much higher current than that required for subthreshold region operation. The modulating signal, the Ramp, turns the drive transistor on and off based on the voltage present at its gate. That voltage is set utilizing a self biasing technique that ensures compensation of the threshold voltage variability present in the semiconductor fabrication process. The gray level information and threshold voltage compensation information are stored in the storage capacitor. One terminal of the storage capacitor is connected to the drive transistor gate, the other to the Ramp terminal.

During self-biasing, the Ramp terminal is at a fixed voltage. After the information has been stored, the Ramp terminal voltage is modulated. Because the storage capacitor has the signal and compensation information, a common Ramp can be applied to all pixels in the array. The array's pixel drive transistor will turn off and turn on uniformly, yielding a current pulse of equal amplitude and duration at each pixel (assuming the source signal was the same for all pixels, as is the case when displaying a flat field). The amplitude of the current is such that it will force the OLED device into a strong ON state. As such, the amplitude is not used for gray level generation for typical application, but may be useable for very low light level application. The duration of the current pulse is the primary contributor to the gray level.

It is therefore, a prime object of the present invention, to eliminate or at least minimize the pixel to pixel non-uniformity that exists in today's AMOLED microdisplays.

It is another object of the present invention to provide an AMOLED pixel cell design that is also applicable to larger format displays that use an active matrix architecture.

It is another object of the present invention to provide an AMOLED pixel cell design that results in better image quality required for large volume application.

2. Description of Prior Art Including Information Disclosed Under 37 CFR 1.97 and 1.98

Many publications (SID Symposium Proceedings 2001 through 2004) have addressed the problem of overcoming threshold voltage variation for poly and amorphous silicon based direct view AMOLED displays. We are also aware of several published patent applications which relate to this issue, including: US20030234754; US20040021653 and US20040032217.

The techniques published by OLED display designers mostly address direct view displays (displays having a diagonal greater than 2″ typically) using non-crystalline silicon processes. They were primarily developed to address the high threshold voltage variability inherent to these processes. Because of the relative large display size (when compared to microdisplays), there is no need for very low current operation and therefore none of these displays make use of the subthreshold region.

The threshold voltage compensation techniques described in these publications are of two types:
voltage based compensation using a second storage capacitor to store the threshold voltage at each pixel.
current based compensation using a technique similar to that first developed in the eMagin Corporation SVGA+OLED microdisplay as described in O. Prache, “Full-color SVGA+OLED-on-silicon microdisplay”, Journal of the SID, pp 133-138, 2002.

However, the most relevant prior art of which we are aware is a Hitachi circuit design, published in the SID Symposium Proceedings of 2002, 2003 and 2004. All of the other implementations known to us have very different schemes from that of the proposed innovation.

The Hitachi design operates in a different mode from the proposed innovation in that the entire pixel array is first written to, and then illumination phase follows. This is because the ramp signal is applied to the data line instead of a separate line. The Hitachi method has limitations with respect to displays having a large number of rows combined with the leakage characteristics of the storage capacitor. In addition, it mandates the use of a system level frame storage in order to be compatible with conventional raster scanned video sources. Our invention does not have such limitations.

The Hitachi design requires two distinct steps to first capture the local threshold voltage and then program the storage capacitor with the data signal. The present invention combines both steps into one, thereby avoiding signal distortions due to the abrupt turn off of the driver transistor.

Further, the Hitachi design has the information storage capacitor connected directly to the data line, making it very susceptible to crosstalk, which can degrade image quality and limit the number of available gray levels. The present invention shields the storage element from the data terminal, allowing for high precision drive.

### BRIEF SUMMARY OF THE PRESENT INVENTION

In general, the present invention employs time domain modulation to control the pixel drive transistor such that it yields an average current to drive the OLED. That current drives the transistor in the active (saturation) region at a level substantially above that which is necessary for operation in the subthreshold region.

The control signal, herein referred to as the RAMP signal, switches the transistor on and off in accordance with the voltage applied at the gate of the transistor.

The voltage applied to the drive transistor gate is to obtain utilizing a self-biasing process which compensates for the variations in the threshold voltage that result from the semiconductor fabrication process.

The gray level information, represented by the average current from the pixel drive transistor, and the compensation signal are stored in a storage capacitor. One terminal of the storage capacitor is connected to the drive transistor gate. The other terminal of the storage capacitor receives the RAMP signal.

During the period when the self-biasing is taking place, the RAMP signal is set at a fixed voltage. After the compensation information has been stored in the storage capacitor, the RAMP voltage is modulated.

Since the storage capacitor stores the RAMP signal and the compensation information, a common RAMP signal may be applied to each of the pixels present in the pixel array.

The array's pixel drive transistors will thus turn on and turn off uniformly, resulting in a current pulse of equal amplitude and direction at each pixel, as long as the source signal is the same for all pixels such as would occur when a flat field is displayed.

Because the amplitude of the current will force the diode into a strong on state, the present invention is particularly well suited for very low light applications. It is the duration of the current pulse that is responsible for most of the control of the gray level.

In accordance with one aspect of the present invention, a drive circuit is provided for an OLED pixel display. The drive circuit is adapted for use with a reference voltage source. It includes a first transistor and an OLED. The output circuit of the first transistor is operably connected between the reference voltage source and the OLED. Transmission gate means responsive to a control signal are provided to transmit a data signal to the first transistor. Means are provided for controlling the first transistor in accordance with a time domain modulation signal to provide an average current to the OLED which is a function of the data signal.

The means for controlling the first transistor includes a storage capacitor having one side connected to receive the time domain modulation signal. The other side of the capacitor is operably connected to the gate of the first transistor. The time domain modulation signal preferably takes the form of a voltage signal having a generally triangular shaped waveform. The voltage signal is provided after the transmission gate means is turned off by the control signal.

The means for controlling the first transistor also includes a second transistor. The second transistor has an output circuit operably interposed between the first transistor and the OLED. Means are provided for turning the second transistor off when the control signal causes the transmission gate means to transmit the data signal to the first transistor.

The circuit also includes a diode configured PMOS transistor. That transistor operably connected between ground and a node situated between the first transistor and the OLED to protect the circuit from shorts across the OLED.

In an alternate preferred embodiment, the second transistor has an output circuit operably interposed between the first transistor and ground. Means are provided for applying a constant DC bias signal to the gate of the second transistor.

In another preferred embodiment, an inverter transistor may be operably interposed between the OLED and a node between the output circuit of the first transistor and the output circuit of the second transistor. A fifth transistor is operably connected between the output circuit of the inverter transistor and ground.

In accordance with another aspect of the present invention, a drive circuit is provided for an OLED pixel display. The circuit is adapted for use with a reference voltage source. The circuit includes a first transistor and an OLED. The output circuit of the first transistor is operably connected between the reference voltage source and the OLED. Transmission gate means are adapted to be turned on in response to a control signal to transmit a data signal to the first transistor, A storage capacitor is provided having one side connected to receive a time domain modulation signal and the other side connected to the gate of the first transistor. A second transistor has an output circuit operably interposed between the first transistor and the OLED. The second transistor is turned off when the transmission gate means is turned on by the control signal to transmit the gate signal to the first transistor. The time domain modulation signal preferably takes the form of a voltage signal having a generally triangular shaped waveform that is provided after the transmission gate means is turned off.

In accordance with another aspect of the present invention, a device circuit is provided for an OLED pixel display. The circuit is adapted for use with a reference voltage source. The circuit includes a first transistor and an OLED. The output circuit of the first transistor is operably connected between the reference voltage source and the OLED. Transmission gate means responsive to a control signal transmits a data signal to the first transistor. A storage capacitor is provided having one side connected to receive a time domain modulation signal and the other side which is operably connected to the gate of the first transistor. The time domain modulation signal preferably takes the form of a voltage signal having a generally triangular shaped waveform that is provided after transmission gate means is turned off. A second transistor is also provided. The second transistor has an output circuit operably interposed between the first transistor and ground. Means are also provided for applying a constant DC bias signal to the gate of the second transistor.

An inverter transistor is provided. The inverter transistor is operably interposed between the OLED and a node between the output circuit of the first transistor and the output circuit of the second transistor.

In accordance with another aspect of the present invention, a drive circuit is provided for an OLED pixel display. The circuit is adapted for use with a reference voltage source. The circuit includes a first transistor and an OLED. The output circuit of the first transistor is operably connected between the reference voltage source and the OLED. Transmission gate means responsive to a control signal transmits a data signal to the first transistor. A storage capacitor is provided having one side connected to receive a time domain modulation signal and the other side operably connected to the gate of the first transistor. The time domain modulation signal preferably takes the form of a voltage signal having a generally triangular shaped waveform that is provided after the transmission gate means is turned off by the control signal. A second transistor is also provided. The second transistor has an output circuit operably interposed between the first transistor and the OLED. Means are provided for turning the second transistor off when the transmission gate means transmits the data signal to the first transistor. An inverter transistor is operably interposed between the OLED and a node between the output circuit of the first transistor and the output circuit of the second transistor. Further, a fifth transistor is operably connected between the output circuit of the inverter transistor and ground.

In accordance with another aspect of the present invention, a display is provided including first and second pixels. Each of the pixels includes an OLED and a drive circuit for the OLED and is adapted for use with a reference voltage source. Each of the drive circuits includes a first transistor having an output circuit operably connected between the reference voltage source and the OLED. It also includes transmission gate means responsive to a control signal to transmit a data signal to the first transistor. Means are provided for controlling the first transistor of each of the pixels with a time domain modulation signal to provide an average current to the OLED which is a function of the data signal. The time domain modulation signal preferably takes the form of a voltage signal with a generally triangular shaped waveform.

### BRIEF DESCRIPTION OF THE SEVERAL VIEWS OF DRAWINGS

To these and to such other objects that may hereinafter appears, the present invention relates to an OLED active matrix pixel designed for optimal uniformity as set forth in detail in the following specification as is noted in the annexed claims, taken together with the accompanying drawings in which like numerals refer to like parts and in which:

FIG. 1 is a schematic diagram of the first preferred embodiment of pixel cell circuit of the present invention;

FIG. 2 is a pixel driver timing diagram of FIG. 1;

FIG. 3 is a schematic diagram of a second preferred embodiment of the present invention;

FIG. 4 is a schematic diagram of a third preferred embodiment of the present invention.

### DETAILED DESCRIPTION OF THE INVENTION

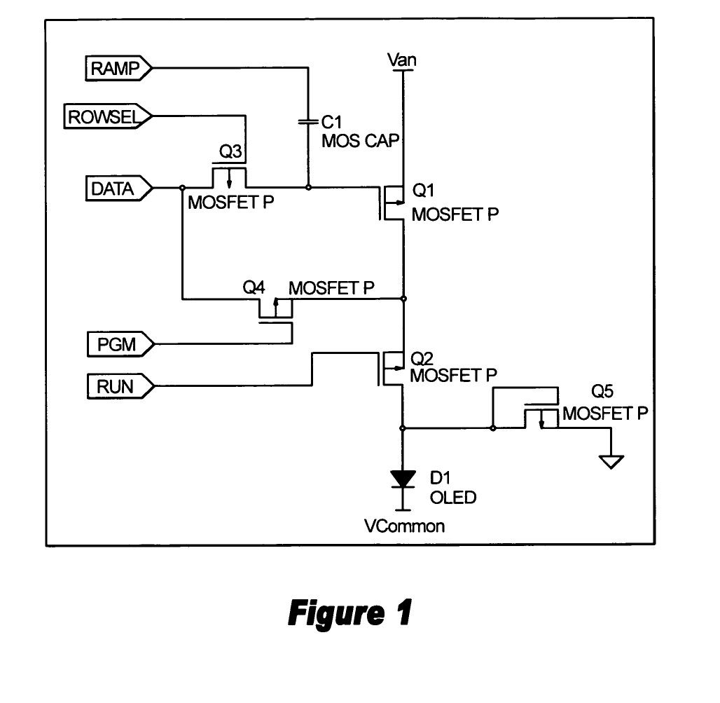

FIG. 1 shows a first preferred embodiment of the present invention in which the OLED pixel driver is a current source formed by a drive transistor Q1 and a storage capacitor C1. The voltage stored across capacitor C1 sets the current that flows through the output circuit of drive transistor Q1 and into OLED D1 (when the Run transistor Q2 is turned on). OLED D1 emits a light proportional to the current flowing through it.

Transistor Q5 is a diode configured PMOS transistor that protects the rest of the pixel driver from possible shorts across OLED D1.

The Run transistor Q2 is turned off during the pixel driver programming phase. It is turned on during the Run phase to allow light emission.

Transistors Q3 and Q4 form a transmission gate means that is responsive to control signals to program the pixel driver with the source data information. The DATA terminal is connected to a current sink whose value represents the desired light (or gray) level. The combination of transistors Q4, Q3 and Q1 and capacitor C1 provides for a self-biasing circuit that mirrors the DATA current into drive transistor Q1 and charges capacitor C1 until the current flowing through drive transistor Q1 is exactly that sunk through the DATA terminal. This happens regardless of drive transistor Q1's actual threshold voltage. Transistors Q3 and Q4 are turned on during this phase, called the programming phase. The RAMP terminal is held at a constant voltage level while capacitor C1 is being charged.

When the gate voltage of drive transistor Q1 has stabilized (drive transistor Q1 provides all the current sunk by the DATA terminal), transistors Q4 and Q3 are turned off and transistor Q2 is turned on, allowing current to flow through drive transistor Q1 to OLED D1. At the same time, the RAMP terminal is switched to a triangular voltage waveform running at the horizontal rate period. This varies the voltage level at the gate of drive transistor Q1 and controls how long drive transistor Q1 will remain on during the line period. The on time is proportional to the voltage across capacitor C1, which is proportional to the desired gray level. A pulse width modulation is therefore achieved and the light emitted by OLED D1 is proportional to the average current flowing through it over the frame period.

Considering two pixel drivers having a different threshold voltage at the drive transistor Q1 (the threshold voltage of the other transistors of the pixels are not relevant given their mode of operation) programmed to provide the same current. When the voltage applied to the RAMP terminal increases, the output current through the drive transistors of each pixel will decrease by the same amount since the voltage across each storage capacitor includes the threshold voltage difference. The result is a uniform response for these two pixels, and consequently for the displayed image.

The design shown above applies to convention CMOS semi-conductor processes but can be extended to non-crystalline semi-conductor technologies such as poly or amorphous silicon as well.

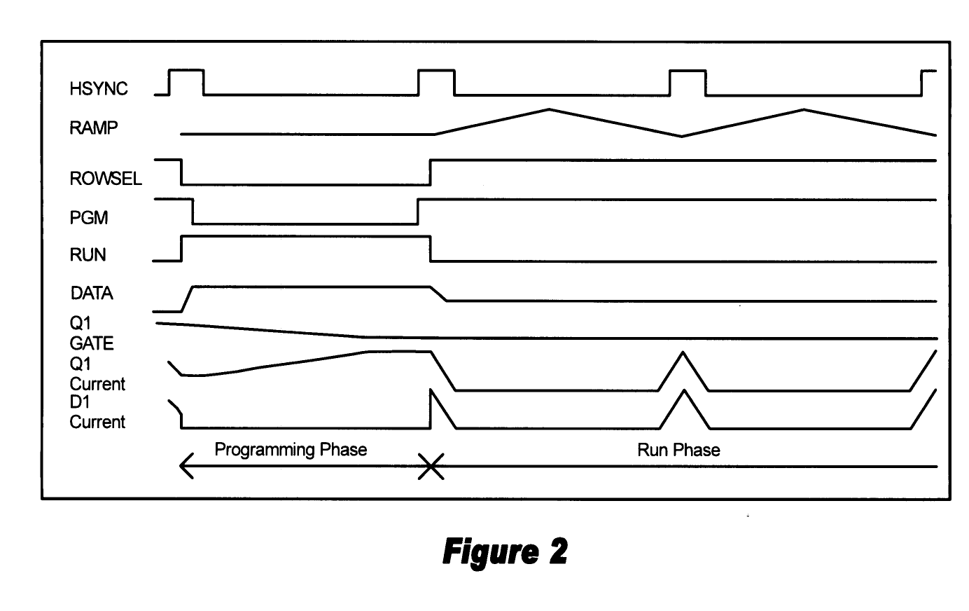

The timing diagram of FIG. 2 illustrates the sequence of operation of the pixel driver circuit of FIG. 1. In FIG. 2, the HSYNC signal is the line synchronization reference, which is provided for reference. Further, the use of PMOS transistors is reflected in the “active low” nature of the control signals.

The Programming Phase:

Upon detection of a new HSYNC period, the ROWSEL control signal is activated for the next active row in the pixel array. This turns on transistor Q3 of the transmission gate means. At the same time, the Run transistor Q2 is turned off, blocking current through the OLED D1. The current to OLED D1 then goes to zero.

A short time after transistor Q2 is turned off, transistor Q4 of the transmission gate means is turned on via the control signal PGM, effectively connecting transistor Q1 to the DATA line. The DATA signal is a current sink, external to the pixel driver and connected at the end of the DATA column in the pixel array.

Depending on the previous voltage level at the gate of transistor Q1, the effect of the DATA current will be a charge or discharge of the storage capacitor C1. FIG. 2 assumes a charge (larger voltage drop across capacitor C1 resulting in a larger gate-source voltage for transistor Q1).

As capacitor C1 charges, the current flowing through the output circuit of transistor Q1 increases until it is equal to the DATA current. At this point, capacitor C1 has reached its desired charge and the gate voltage level of transistor Q1 stabilizes. Depending on the value of the DATA current, corresponding to the gray level desired, this level will take more or less time to stabilize.

During this time period, the voltage level at the RAMP terminal of the storage capacitor is held constant. The exact value depends on the semiconductor process and pixel cell size.

The Run Phase:

At the beginning of the next line period, transistors Q3 and Q4 of the transmission gate means are turned off and Q2 is turned on. At the same time, a triangular voltage signal is connected to the RAMP terminal of storage capacitor C1. This signal operates at the HSYNC frequency and is applied to all but one row of the active matrix (the row being programmed used a dc level for its Ramp terminal as mentioned above).

The Ramp voltage pushes the gate level of transistor Q1 up and down. When the gate of transistor Q1 crosses the threshold voltage, transistor Q1 turns on (RAMP signal going down to a lower voltage level) or turns off (RAMP signal going up to a higher level). During the time that transistor Q1 is on, the current flows up to a limit set by either the current capacity of OLED D1 or the actual current programmed into the pixel.

Transistor Q1 is on only for a fraction of the line period. During this time, the OLED D1 is fully turned on (the assumption being that the current is pushing the OLED into saturation, which the design premise). Gray scale is achieved by averaging the OLED on time over a wide frame period.

The average light intensity is linear with respect to the on time, which is linear with respect to the voltage across capacitor C1, which in turn is linear with respect to the current sunk by the DATA terminal.

Nonlinear response can be achieved by modification of the RAMP signal shape, both in terms of slope and duty cycle.

Dimming of the display can be achieved by controlling the RAMP signal offset as well to increase/decrease the on time. Additionally, the RAMP signal slope can also be used to effect dimming control.

Alternate Implementations:

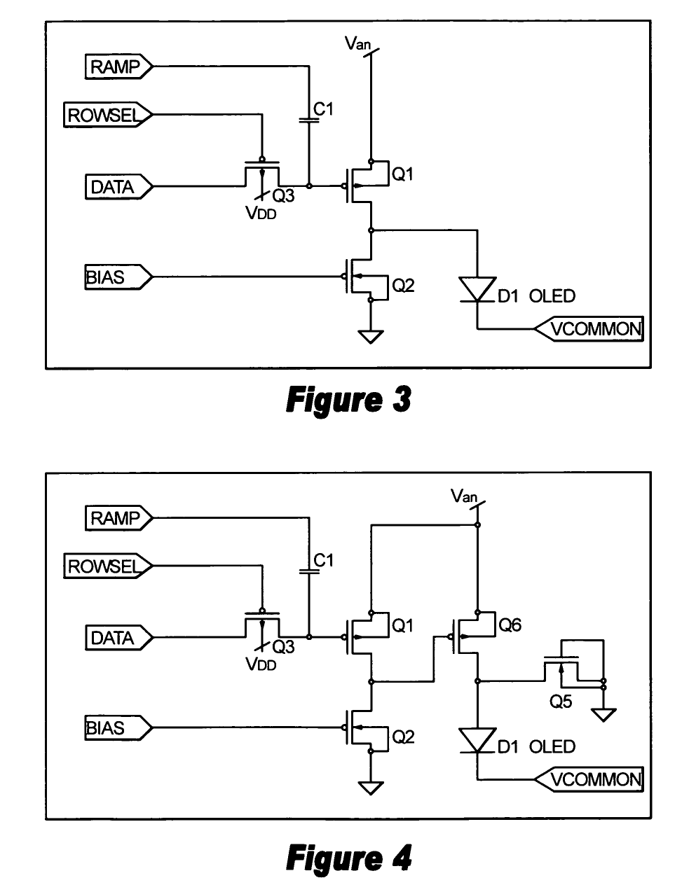

Second and third preferred embodiments of the present invention are shown in FIGS. 3 and 4. Each illustrates a pixel cell circuit design which utilizes the RAMP signal to control the OLED diode light output. These designs operate on the pulse width modulation (PWM) principle, as does the circuit of FIG. 1, but employs voltage programming instead of current programming to set the PWM threshold level. The advantage is either a simpler pixel topology with fewer transistors as shown in FIG. 3, or a better control of timing accuracy with the design shown in FIG. 4. The drawback is a slightly higher average current consumption than the circuit in FIG. 1.

In the circuits of the second and third preferred embodiments, a BIAS control line has been added to provide a current load for the common source gain amplifier formed by the transistor Q1. This signal is a pure DC voltage and does not change under any operational condition. It ensures a more uniform switching threshold across the entire PWM control range. At the same time, the RUN and PGM control lines have been eliminated.

As seen in FIGS. 3 and 4, transistor Q4 of the transmission gate means of FIG. 1 has been eliminated. Further, transistor Q2 now receives a constant DC bias voltage instead of the RUN signal and is now connected between ground and a node situated between the output circuit of transistor Q1 and OLED D1. Transistor Q5 has been eliminated in FIG. 3.

In FIG. 4, a second inverter transistor Q6 has been added. The gate of transistor Q6 is connected to a node between the output circuits of transistors Q1 and Q2.

The Program Phase:

The operational timing sequence for both versions of the voltage programmed cell is similar to that shown in FIG. 2. Upon detection of a new HSYNC period, the ROWSEL control signal is activated for the next active row in the pixel array. This turns on transistor Q3, connecting transistor Q1 to the DATA line. The DATA signal is a voltage source, external to the pixel driver and connected at the end of the DATA column in the pixel array. During this time, the RAMP terminal of storage capacitor C1 is brought to a reference level and held constant. The exact value for the reference level depends on the semiconductor process but it will be equal to either the peak or valley of the RAMP signal waveform. For this example, the reference level is considered to be equal to the lowest point on the RAMP signal waveform as shown in FIG. 2.

Depending on the previous voltage level at the gate of transistor Q1, the effect of the DATA voltage will be to charge or discharge storage capacitor C1. FIG. 2 assumes the voltage across capacitor C1 is charged to a larger value with respect to the RAMP signal reference level. The allowed values for the DATA signal and the RAMP signal waveform are such that transistor Q1 will always enter the conducting state during the program phase. This will ensure that the full reference supply voltage Van is applied across the OLED D1 in the case of FIG. 3. The current through the OLED will be self limited by the saturation value of the OLED device. For the case shown in FIG. 4, both the drain node of transistor Q1 and the gate of transistor Q6 will rise to the positive supply rail. Consequently, Q6 is fully turned off and the current through OLED D1 drops to its off state value.

For the circuit in FIG. 3, the OLED D1 is clamped to ground by the drain to substrate junction of transistor Q2. In the case of the circuit of FIG. 4, an additional device Q5 must be added to perform this function. Transistor Q5 can be either a PMOS as in FIG. 1 or an NMOS as shown in FIG. 4.

The Run Phase:

At the beginning of the next line period, transistor Q3 is turned off. At the same time, a triangular or sawtooth voltage RAMP signal is connected to the RAMP terminal of the capacitor C1. This signal may operate at the HSYNC frequency or a lower frequency (up to an including the frame rate) and is applied to all but the one row of the active matrix that is being programmed.

The RAMP voltage signal pushes the gate level of transistor Q1 up and down. When the gate of transistor Q1 crosses the threshold voltage, transistor Q1 turns off (RAMP going up to a higher level) or on (RAMP going down to a lower level). During the time transistor Q1 is on, the current in OLED D1 flows up to a level determined by the current capacity of OLED D1 for the circuit shown in FIG. 3. For the case of the circuit of FIG. 4, the current flow through OLED D1 is reversed with the state of transistor Q1. That is, the current in OLED D1 flows when transistor Q1 turns off since Q6 turns on at that time. The control of average light intensity is the same as described previously for the circuit in FIG. 1.

It should now be appreciated that the present invention relates to an OLED active matrix pixel cell design that provides optimal pixel to pixel uniformity not present in conventional AMOLED microdisplays. The design is also applicable to larger format displays that use an active matrix architecture. It provides the better image quality required for large volume applications.

While only a limited number of preferred embodiments of the present invention have been disclosed for purposes of illustration, it is obvious that many modifications and variations could be made thereto. It is intended to cover all of those modifications and variations which fall within the scope of the present invention, as defined by the following claims.

We claim:

1. A drive circuit for an OLED pixel display adapted for use with a reference voltage source comprising a first transistor and an OLED, the output circuit of said first transistor being operably connected between the reference voltage source and the OLED, transmission gate means responsive to a control signal to transmit a data signal to said first transistor and means for controlling said first transistor in accordance with a time domain modulation signal to provide an average current to the OLED which is a function of the data signal.

2. The circuit of claim 1 wherein said means for controlling said first transistor comprises a storage capacitor having one side connected to receive said time domain modulation signal and the other side operably connected to the gate of said first transistor, wherein said time domain modulation signal comprises a voltage signal having a generally triangular shaped waveform, said voltage signal being provided after said transmission gate means is turned off by said control signal.

3. The circuit of claim 2 wherein said means for controlling said first transistor further comprises a second transistor, said second transistor having an output circuit operably interposed between said first transistor and the OLED and means for turning said second transistor off when said control signal causes said transmission gate means to transmit the data signal to said first transistor.

4. The circuit of claim 1 further comprising a diode configured PMOS transistor operably connected between ground and a node situated between said first transistor and the OLED.

5. The circuit of claim 2 wherein said means for controlling said first transistor further comprises a second transistor, said second transistor having an output circuit operably interposed between said first transistor and ground, and means for applying a constant DC bias signal to the gate of said second transistor.

6. The circuit of claim 5 further comprising an inverter transistor operably interposed between the OLED and a node between the output circuit of said first transistor and the output circuit of said second transistor.

7. The circuit of claim 6 further comprising a fifth transistor operably connected between the output circuit of said inverter transistor and ground.

8. A drive circuit for an OLED pixel display adapted for use with a reference voltage source comprising a first transistor and an OLED, the output circuit of said first transistor being operably connected between the reference voltage source and the OLED, transmission gate means adapted to be turned on in response to a control signal to transmit a data signal to said first transistor, a storage capacitor having one side connected to receive a time domain modulation signal and the other side connected to the gate of said first transistor, a second transistor having an output circuit operably interposed between said first transistor and the OLED, said second transistor being turned off when said transmission gate means is turned on by the control signal to transmit the date signal to said first transistor, wherein said time domain modulation signal comprises a voltage signal having a generally triangular shaped waveform that is provided after said transmission date means is turned off.

9. A device circuit for an OLED pixel display adapted for use with a reference voltage source comprising a first transistor and an OLED, the output circuit of said first transistor being operably connected between the reference voltage source and the OLED, transmission gate means responsive to a control signal to transmit a data signal to said first transistor, a storage capacitor having one side connected to receive a time domain modulation signal and the other side operably connected to the gate of said first transistor, wherein said time domain modulation signal comprises a voltage signal having a generally triangular shaped waveform that is provided after transmission gate means is turned off, a second transistor, said second transistor having an output circuit operably interposed between said first transistor and ground, and means for applying a constant DC bias signal to the gate of said second transistor.

10. The circuit of claim 9 further comprising an inverter transistor operably interposed between the OLED and a node between the output circuit of said first transistor and the output circuit of said second transistor.

11. A drive circuit for an OLED pixel display adapted for use with a reference voltage source comprising a first transistor and an OLED, the output circuit of said first transistor being operably connected between the reference voltage source and the OLED, transmission gate means responsive to a control signal to transmit a data signal to said first transistor, a storage capacitor having one side connected to receive a time domain modulation signal and the other side operably connected to the gate of said first transistor, wherein said time domain modulation signal comprises a voltage signal having a generally triangular shaped waveform that is provided after said transmission gate means is turned off by the control signal, a second transistor, said second transistor having an output circuit operably interposed between said first transistor and the OLED and means for turning said second transistor off when said transmission gate means transmits the data signal to said first transistor, an inverter transistor operably interposed between the OLED and a node between the output circuit of said first transistor and the output circuit of said second transistor, and a fifth transistor operably connected between the output circuit of said inverter transistor and ground.

12. A display comprising first and second pixels, each of said pixels comprising an OLED and a drive circuit for the OLED and being adapted for use with a reference voltage source, each of said drive circuits comprising a first transistor having an output circuit operably connected between the reference voltage source and the OLED, transmission gate means responsive to a control signal to transmit a data signal to said first transistor and means for controlling said first transistor of each of said pixels with a time domain modulation signal to provide an average current to the OLED which is a function of the data signal.

13. The display of claim 12 wherein said time domain modulation signal comprises a voltage signal with a generally triangular shaped waveform.
